(19) United States
(12) Patent Application Publication
(10) Pub. No.: US 2016/0246467 A1
(43) Pub. Date: Aug. 25, 2016

(54) AUTOMATICALLY GENERATING A WALKTHROUGH OF AN APPLICATION OR AN ONLINE SERVICE

(71) Applicant: salesforce.com, inc., San Francisco, CA (US)

(72) Inventors: Daniel Everett Jemiolo, Cary, NC (US); Joel Benjamin Allen, Mebane, NC (US); Ryan Eric Smith, Durham, NC (US)

(21) Appl. No.: 14/630,976

(22) Filed: Feb. 25, 2015

(51) Int. Cl. G06F 3/0484; G06F 17/30

(52) U.S. Cl. CPC G06F 3/0484; G06F 17/30312

(57) ABSTRACT

Disclosed are examples of systems, apparatus, methods and computer program products for automatically generating a walkthrough of an application or an online service. For example, a database storing data objects identifying walkthrough stages can be maintained. Each walkthrough stage can be associated with one or more features of an application or a service. An identification of a first feature of a first application or service can be received. It can be determined that the first feature is associated with a first user interface layout of the application when presented in a user interface of a computing device. One or more of the walkthrough stages can be identified as being relevant based on the first user interface layout and one or more data objects in the database. The one or more relevant walkthrough stages can be processed to generate a walkthrough. The walkthrough can be stored as a data file in a database of a database system. The walkthrough can be configured to be accessed via the data network and interacted with using the computing device.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to walkthroughs of applications or online services. More specifically, this patent document discloses techniques for automatically generating a walkthrough of an application or an online service.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

### BRIEF DESCRIPTION OF THE DRAWINGS

The included drawings are for illustrative purposes and serve only to provide examples of possible structures and operations for the disclosed inventive systems, apparatus, methods and computer program products for automatically generating a walkthrough of an application or an online service. These drawings in no way limit any changes in form and detail that may be made by one skilled in the art without departing from the spirit and scope of the disclosed implementations.

FIG. 1 shows a flowchart of an example of a method 100 for automatically generating a walkthrough of an application or an online service, performed in accordance with some implementations.

FIG. 2 shows a block diagram of an example of a Walkthrough Database 200, in accordance with some implementations.

FIGS. 3A and 3B show examples of presentations of walkthrough stages in the form of graphical user interfaces (GUIs) as displayed on a computing device, in accordance with some implementations.

FIGS. 4A and 4B show examples of presentations of features of a web application in the form of GUIs as displayed on a computing device, in accordance with some implementations.

FIG. 5A shows a block diagram of an example of an environment 10 in which an on-demand database service can be used in accordance with some implementations.

FIG. 5B shows a block diagram of an example of some implementations of elements of FIG. 5A and various possible interconnections between these elements.

FIG. 6A shows a system diagram of an example of architectural components of an on-demand database service environment 900, in accordance with some implementations.

FIG. 6B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer program products are configured for generating walkthroughs. The concept of walkthroughs as discussed herein encompasses a range of subject matter. A walkthrough generally refers to an interactive presentation for training a user to use any computing application or online service such as, but not limited to, a cloud-based enterprise application. In some implementations, a walkthrough can be provided using a server-based database system to deliver hands-on training to employees, customers, or other individuals at their computing devices. By way of illustration, such hands-on training can merge interactive e-learning tutorials with guided exercises within the same training application.

Manually generating walkthroughs for new features of an application or service, such as record types, buttons, fields, etc., can take an excessive amount of time and resources. By way of example, Miranda is the Chief Executive Officer (CEO) of Tempest Freight, a small shipping business that is about to unveil a new online platform. Tempest Freight does not have the resources or staff to manually generate walkthroughs to train their employees and customers to use each of the thousands of new features of the online platform. Traditionally, Miranda might have to hire new employees or stretch her over-worked staff even thinner to generate walkthroughs.

Using some of the disclosed techniques, walkthroughs for some features can be generated automatically, saving time and money, and allowing Tempest Freight to release their online shipping platform as quickly as possible. For example, in some implementations, a walkthrough can be automatically generated whenever a new feature is edited or created by using a database containing Tempest Freight's previously generated walkthrough stages. As used herein, the term “walkthrough stage” refers to a segment or portion of a walkthrough, as described in greater detail below. By way of illustration, Prospero is a software developer at Tempest Freight working on the new online platform. He generates an international tracker, which is a type of record in the Tempest platform that is used to track the status of international shipments. Several days earlier, Prospero generated a domestic tracking walkthrough for a similar domestic tracker record type that allows users of the Tempest platform to track domestic shipments. Each stage of the previously generated domestic tracking walkthrough is currently stored in Tempest Freight's walkthrough database. When Prospero creates the new international tracker, a database system can identify stages in the domestic tracking walkthrough that are relevant to the international tracker, based on similarities of the domestic tracker and the international tracker. The database system can modify the identified walkthrough stages such that they are applicable to the international tracker rather than the domestic tracker and combine the modified stages to automatically generate a walkthrough for the international tracking feature as described in further detail below.

In some implementations, an automatically generated walkthrough can be presented as a preview for validation by a user. By way of example, a preview of the automatically generated international tracking walkthrough can be provided in a presentation on Prospero's computing device. Prospero can then validate or edit the walkthrough. For instance, Prospero might want to supplement the automatically generated walkthrough for the international tracker with text in several languages to make the walkthrough more accessible to international clients.

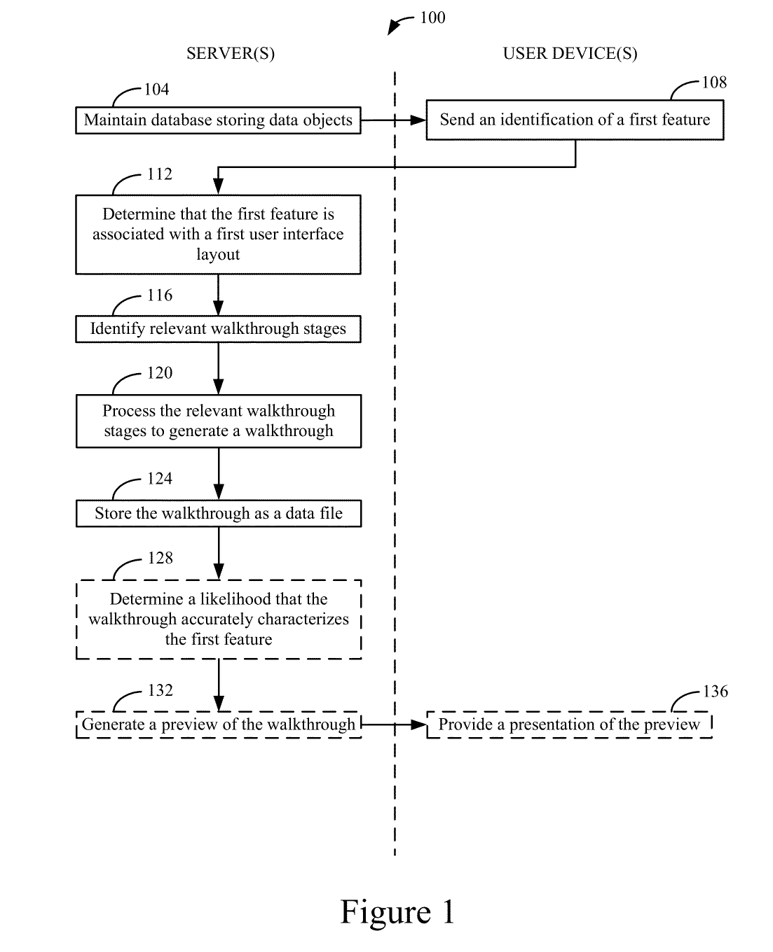

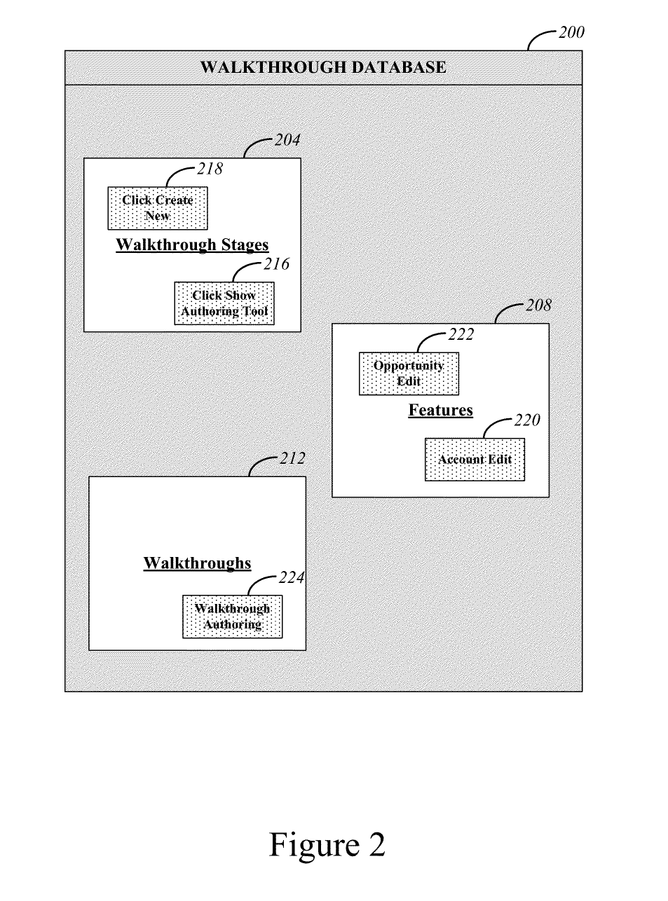

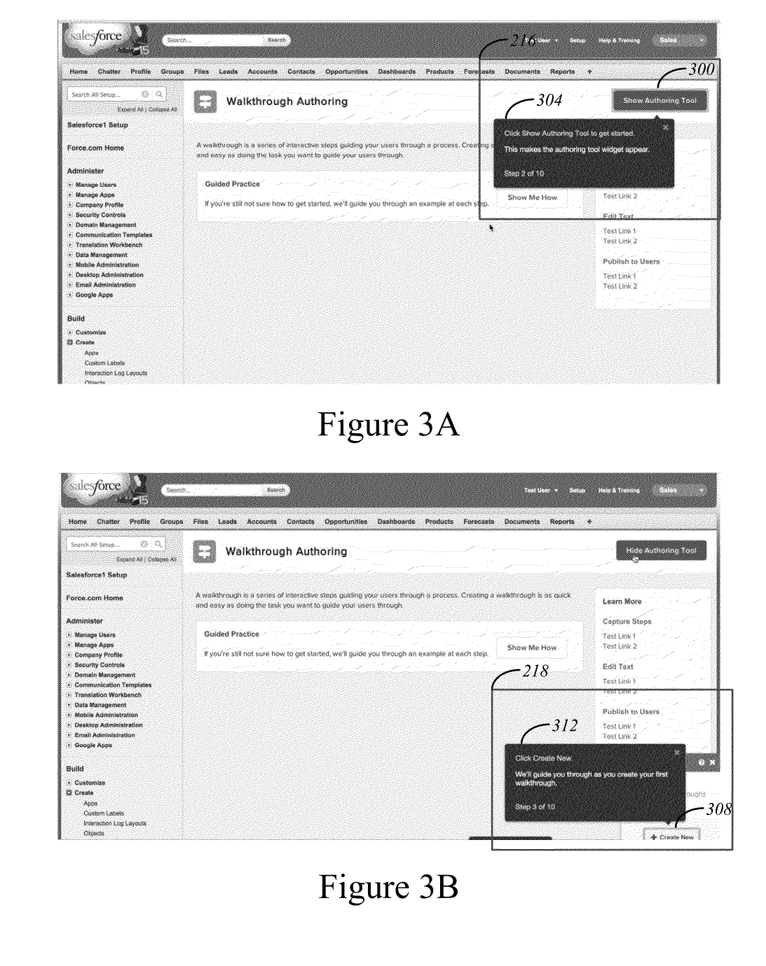

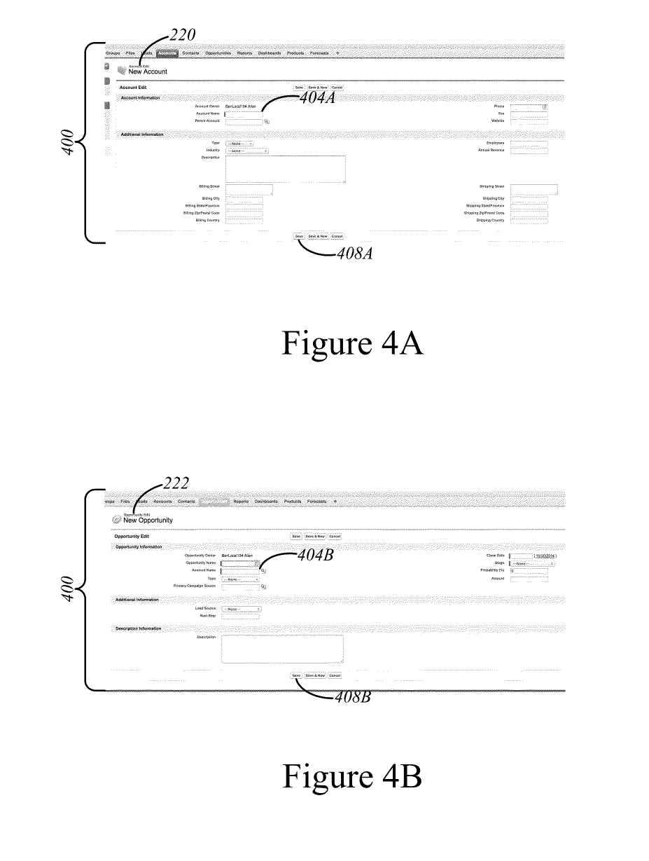

FIG. 1 shows a flowchart of an example of a method 100 for automatically generating a walkthrough of an application or an online service, performed in accordance with some implementations. FIG. 1 is described with reference to FIGS. 2-4B. FIG. 2 shows a block diagram of an example of a Walkthrough Database 200, in accordance with some implementations. FIGS. 3A and 3B show examples of presentations of walkthrough stages in the form of graphical user interfaces (GUIs) as displayed on a computing device, in accordance with some implementations. FIGS. 4A and 4B show examples of presentations of features of a web application in the form of GUIs as displayed on a computing device, in accordance with some implementations.

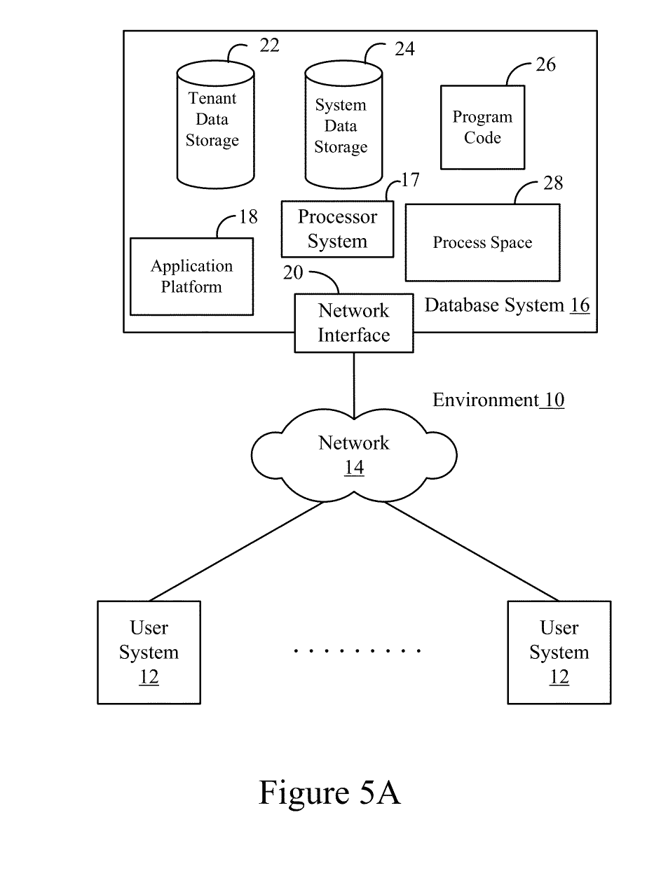

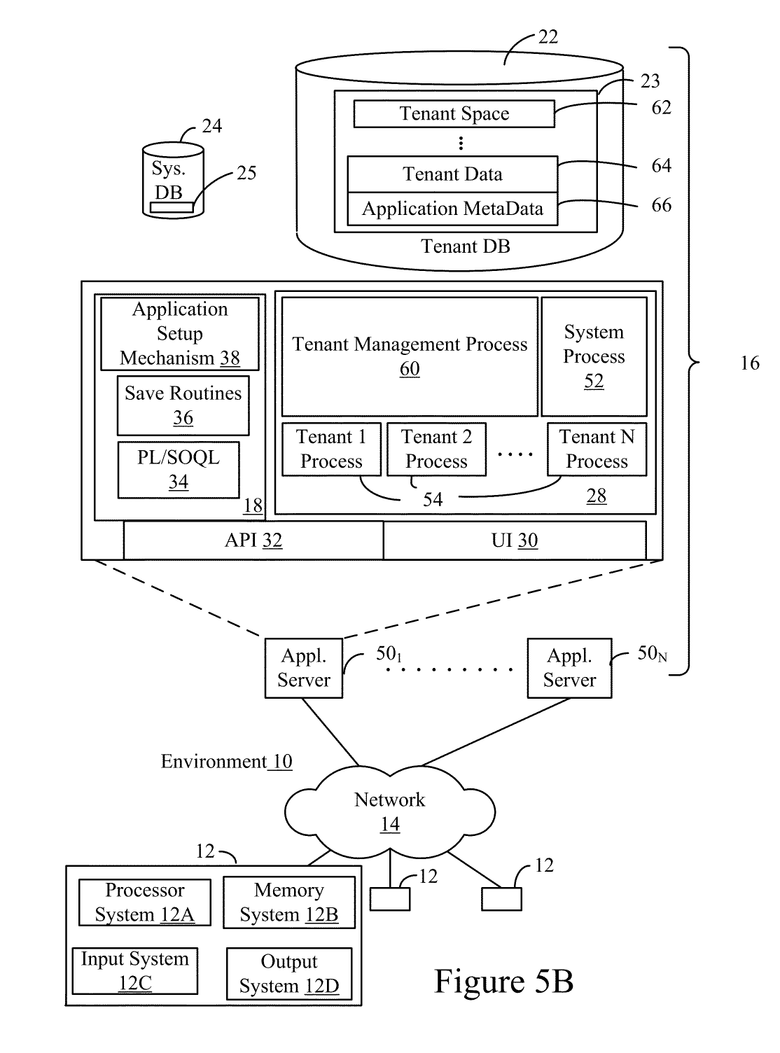

At 104 of FIG. 1, Walkthrough Database 200 of FIG. 2 is maintained. Walkthrough Database 200 can be maintained by servers on behalf of an organization such as Tempest Freight, by a third party such as Salesforce.com®, or both. For example, Walkthrough Database 200 can form part of a database system 16 of FIGS. 5A and 5B. In some cases, walkthrough data can be stored in tenant data storage 22, described in greater detail below. Walkthrough Database 200 can store a wide variety of customizable data objects. For example, in FIG. 2, some data objects in Walkthrough Database 200 might identify walkthrough stages 204. Walkthrough stages 204, which are segments or portions of a walkthrough, can contain both pre-defined walkthrough stages and user-defined walkthrough stages. Specific types of walkthrough stages can vary across implementations. For instance, Click Show Authoring Tool 216 is an example of a walkthrough stage that demonstrates how and when to click or tap Show Authoring Tool Button 300 of FIG. 3A as part of the Walkthrough Authoring 224 walkthrough, as described in more detail below. Click Create New 218, which demonstrates how and when to click or tap Create New Button 308 of FIG. 3B as part of the Walkthrough Authoring 224 walkthrough is another example of a walkthrough stage 204 stored in Walkthrough Database 200.

A walkthrough stage can be defined by a variety of data, such as a target, a label, start and/or completion criteria, etc., which can be stored in Walkthrough Database 200. By way of illustration, Click Show Authoring Tool 216 targets Show Authoring Tool Button 300 of FIG. 3. Additionally, Click Show Authoring Tool 216 is labeled by text box 304. Also or alternatively, a walkthrough stage can be defined by start criteria, which specify the conditions under which a walkthrough stage is displayed, and completion criteria, which specify when the stage is not displayed. By way of illustration, Click Show Authoring Tool 216 is the second walkthrough stage in the Walkthrough Authoring 224 Walkthrough; therefore, the start criterion for Click Show Authoring Tool 216 is met when the preceding stage in the Walkthrough Authoring 224 walkthrough is completed. The completion criterion for Click Show Authoring Tool 216 can be met when its target, Show Authoring Tool Button 304, is clicked or tapped by a user. Along the same lines, the walkthrough stage Click Create New 218, targets Create New Button 308 and is labeled by text box 312. Since Click Create New 218 is immediately preceded by Click Show Authoring Tool 216 in Walkthrough Authoring 224, the completion criterion for Click Show Authoring Tool 216 is the start criterion for Click Create New 218. In other words, Click Create New 218 begins when Click Show Authoring Tool 216 is completed. The completion criterion for Click Create New 218 can be met when Create New Button 308 is clicked or tapped by a user.

Returning to FIG. 2, as discussed above, some data objects in Walkthrough Database 200 can identify user-defined Features 208, such as record types, tabs buttons, fields, etc., of an application or service. Such features can vary greatly across implementations and are described in further detail below. For example, a feature can relate to Customer Relationship Management (CRM) records, such as an account, a task, a lead, a contact, a contract or an opportunity, or another type of data object. By way of example, Walkthrough Database 200 can contain the Account Edit 220 feature, which allows a user to edit or create an account that is storable in a CRM database. Along the same lines, Walkthrough Database 200 can contain the Opportunity Edit 222 feature, which allows a user to edit or create an opportunity which can be stored in a CRM database.

In some implementations, some data objects in Walkthrough Database 200 might also identify Walkthroughs 212 such as Walkthrough Authoring 224. Walkthrough Authoring 224 is a walkthrough demonstrating how to author walkthroughs.

Returning to FIG. 1, at 108, an identification of the Account Edit 220 feature is received by a database system. For example, a user, such as Prospero, might create the Account Edit 220 feature and request that request that a walkthrough be generated for Account Edit 220. Also or alternatively, an identification of a new feature might be automatically received, without a request from a user, by the walkthrough database system when the new feature is generated.

At 112, it is determined that, the Account Edit 220 feature contains attributes of User Interface (UI) Layout 400 of FIGS. 4A and 4B. As used herein, the term “UI layout” refers to a classification of a UI which can be defined by a diverse range of attributes. For instance, attributes that define a UI layout can include structures of an application or service that are displayed when a feature is presented in a UI on a computing device such as graphical locations of components such as fields or buttons as well as types of fields or buttons. By way of illustration, UI Layout 400 might be defined by the presence and location of Account Name Fields 404B and 404B and Save Button 408A and 408B. Also or alternatively, a UI Layout can be defined by attributes that are not directly displayed in a UI, such as high level code, a Uniform Resource Locator (URL), a Document Object Model (DOM), etc., as described further below. As such, a variety of attributes can be analyzed to determine an association between a given feature and a user interface layout. For example, a mapping of UIs in a system, such as various pages in a cloud based web application, can be made manually and stored in Walkthrough Database 200. By way of example, Prospero, a user of Walkthrough Database 200 can manually define the Account Edit 220 feature and the Opportunity Edit 222 feature as mapping to UI Layout 400, based on Prospero's subjective analysis of the two features or based on objective criteria such as the location of various buttons, objects, fields, etc. Prospero can then repeat the process and manually map each feature of the Tempest Freight platform with various UI layouts. Such mappings can be stored in Walkthrough Database 200 in association with Account Edit 220, Opportunity Edit 222, and other features.

Also or alternatively, specified data for a record type can define the UI layout for the record. For example, markers in the Document Object Model (DOM) of a web application can be analyzed by a database system to determine any specified data for a certain record. As such, a user interface layout can be determined by analyzing a Document Object Model (DOM) structure of a record. By way of illustration, the Account Edit 220 feature requires a user to enter data into Account Name Field 404A of FIG. 4A. Similarly, the Opportunity Edit 222 feature requires a user to enter data into Account Name Field 404B of FIG. 4B. Therefore, any record type such as accounts and opportunities, that require a user to enter text in an Account Name Field can be mapped to UI Layout 400 and can be identified by a database system at 112 based on such a mapping. In other words, a rules engine can assess the DOM structure of a page in a web application to determine a map between the page and UI layouts in the web application.

Also or alternatively, a UI layout of a page in a web application might be defined based on the URL for the page. By way of illustration, all pages in a web application with a URL containing the string “UI2389F62A234” might be defined as UI Layout A, whereas all pages in a web application with a URL containing the string “UI234BB8594D52” might be defined as UI Layout B. Thus, a UI layout for a page in the web application might be identified by parsing the URL for the page.

At 116 of FIG. 1, relevant walkthrough stages are identified based on UI Layout 400. The manner in which relevant walkthrough stages are identified can vary across implementations. For example, data objects in Walkthrough Database 200 can identify user interface layout and walkthrough stage associations. By way of illustration, Walkthrough Database 200 can identify features containing attributes of UI Layout 400 such as Account Edit 220 and Opportunity Edit 222. Similarly, Walkthrough Database 200 can identify previously generated walkthrough stages for such features. By way of example, a walkthrough has already been generated for Opportunity Edit 222 and all stages of the walkthrough are stored in Walkthrough Database 200. More specifically, Walkthrough Stage A targets Account Name Field 404B of FIG. 4B and Walkthrough Stage Z targets Save Button 408B of FIG. 4B. Thus, Walkthrough Stages A and Z can both be identified as a relevant walkthrough stage at 116, because an association between Walkthrough Stages A and Z and UI Layout 400 is identified in Walkthrough Database 200.

In some implementations, the identification process at 116 can include ranking walkthrough stages. For instance, walkthrough stages can be ranked based on a number of walkthroughs each walkthrough stage is used in. By way of example, if Walkthrough Stage A has been used in 2000 walkthroughs and Walkthrough Stage B has been used in 20 walkthroughs, Walkthrough Stage A can be ranked above Walkthrough Stage B. Thus, Walkthrough Stage A and might be identified as relevant at 116, whereas Walkthrough Stage B might not be identified as relevant at 116 because Walkthrough Stage A is ranked higher than Walkthrough Stage B.

Returning to FIG. 1, at 120, relevant walkthrough stages are processed to generate a walkthrough. The manner in which walkthrough stages are processed to generate a walkthrough can vary across implementations. For example, various elements of a walkthrough stage, such as a URL, a label, or a field, can be replaced. By way of illustration, Walkthrough Stage A, which targets Account Name Field 404B of FIG. 4B is stored in Walkthrough Database 200. The target of Walkthrough Stage A can be replaced with Account Name Field 404A of FIG. 4A such that it targets Account Name Field 404A of the Account Edit 220 feature of FIG. 4A rather than Account Name Field 404B of the Opportunity Edit 222 feature of FIG. 4B. Additionally, the text labelling Walkthrough Stage A can be replaced with text that is applicable to the context of the Account Edit 220 feature rather than Opportunity Edit 222 feature. Along the same lines, Walkthrough Stage Z, which targets Save Button 408B of FIG. 4B is stored in Walkthrough Database 200. Walkthrough Stage Z is completed when a user clicks or taps Save Button 408B of FIG. 4B, leading a first URL. Walkthrough Stage Z can be modified at 120 such that it is completed when a user clicks or taps Save Button 408A of FIG. 4A, leading a second URL.

Also or alternatively, if a number of sequential walkthrough stages are identified at 116 of FIG. 1, the sequential stages can be combined to generate a walk through. By way of illustration, Walkthrough Stages A and Z, which are each targeted to different fields of Account Edit 220 of FIGS. 2, 4A, and 4B, were identified at 116. The 2 stages can be combined sequentially to generate a walkthrough for the Account Edit 220 feature. In other words, Stage A can precede Stage Z in the walkthrough, such that the completion criterion for Stage A is the start criterion for Stage Z, as described above.

At 124 of FIG. 1, the walkthrough generated at 120 is stored in Walkthrough Database 200 of FIG. 2. The walkthrough can then be accessed via a data network, such as the internet, and interacted with by users of Walkthrough Database 200, such as Prospero, by using a computing device.

In some, but not all implementations, at 128 of FIG. 1, a likelihood that the walkthrough generated at 120 accurately characterizes the Account Edit 220 feature of FIG. 4A can be determined. Such a likelihood can be determined in a variety of manners. For example, the likelihood can be generated by applying standard Frequentist or Bayesian statistical inference techniques or predictive analytics to data collected for similar previously generated walkthroughs for various users.

In some but not all implementations, at 132, a preview of the walkthrough is generated and at 136 a presentation of the preview is provided. The preview can to be accessed via a data network such as the internet and interacted with by a user. By way of example, after the walkthrough is generated, Prospero might click or tap a button in the user interface of his iPad® requesting to view the preview. The walkthrough database system can provide data to Prospero's iPad® which can be processed by a processor of the iPad® to display a presentation of the preview. Prospero can then interact with the preview to validate or modify the walkthrough, as described further below. Also or alternatively, if a likelihood is generated at 128, the presentation of the preview might contain a graphical representation of the likelihood, such as an estimated numerical percentage or fractional probability that the previewed walkthrough is accurate.

In some implementations, a user might view a presentation of a preview and decide to modify a walkthrough. By way of illustration, if Prospero views a preview and notices that some text in the preview is inaccurate, he can request to modify the walkthrough by editing the inaccurate text. The walkthrough can then be modified according to Prospero's request and the modified walkthrough can be stored in Walkthrough Database 200.

Some walkthroughs can be dependent on other walkthroughs. In some implementations in which a hierarchical database model is used, a number of child walkthroughs can depend on a parent walkthrough, such that when the parent walkthrough is modified, the child walkthroughs are modified as well. By way of illustration, Tempest Freight has built 234 walkthroughs for their online platform and stored the walkthroughs in Walkthrough Database 200. Several months later, Prospero decides to change various elements of the platform's UI to make the platform more user-friendly for tempest customers. Rather than updating each walkthrough individually to match the new UI, Prospero can update a parent walkthrough upon which the remaining 233 walkthroughs depend. When Tempest Freight's walkthrough database system receives an indication that the parent walkthrough has been updated or generated, the 233 child walkthroughs can be automatically updated accordingly.

Some of the disclosed techniques can be used to provide walkthrough shells or boilerplate walkthroughs. By way of example, if Prospero is tasked with generating 100 walkthroughs for a number of related features, and each walkthrough begins with stages A, B, and C, and ends with stages W, X, Y, and Z, a shell that begins with stages A, B, and C, and ends with stages W, X, Y, and Z can be generated and stored in Walkthrough Database 200. Prospero can then access the walkthrough shell via his computing device and manually fill in the remaining stages in the shell for each of the 100 walkthroughs.

Some of the disclosed techniques can be used to build intelligence to improve automatic walkthrough generation. By way of illustration, Walkthrough Stage D has been included in 100 automatically generated walkthroughs. Each time Walkthrough Stage D is included in an automatically generated walkthrough, a user selects to modify the walkthrough by removing Walkthrough Stage D. Thus, stage D can be restricted such that it is no longer used in automatically generated walkthroughs.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

FIG. 5A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 5A (and in more detail in FIG. 5B) user systems 12 might interact via a network 14 with an on-demand database service, which is implemented in the example of FIG. 5A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 5A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 5A and 5B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 5A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 5B shows a block diagram of an example of some implementations of elements of FIG. 5A and various possible interconnections between these elements. That is, FIG. 5B also illustrates environment 10. However, in FIG. 5B elements of system 16 and various interconnections in some implementations are further illustrated. FIG. 5B shows that user system 12 may include processor system 12A, memory system 12B, input system 12C, and output system 12D. FIG. 5B shows network 14 and system 16. FIG. 5B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 5A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 5B, system 16 may include a network interface 20 (of FIG. 5A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

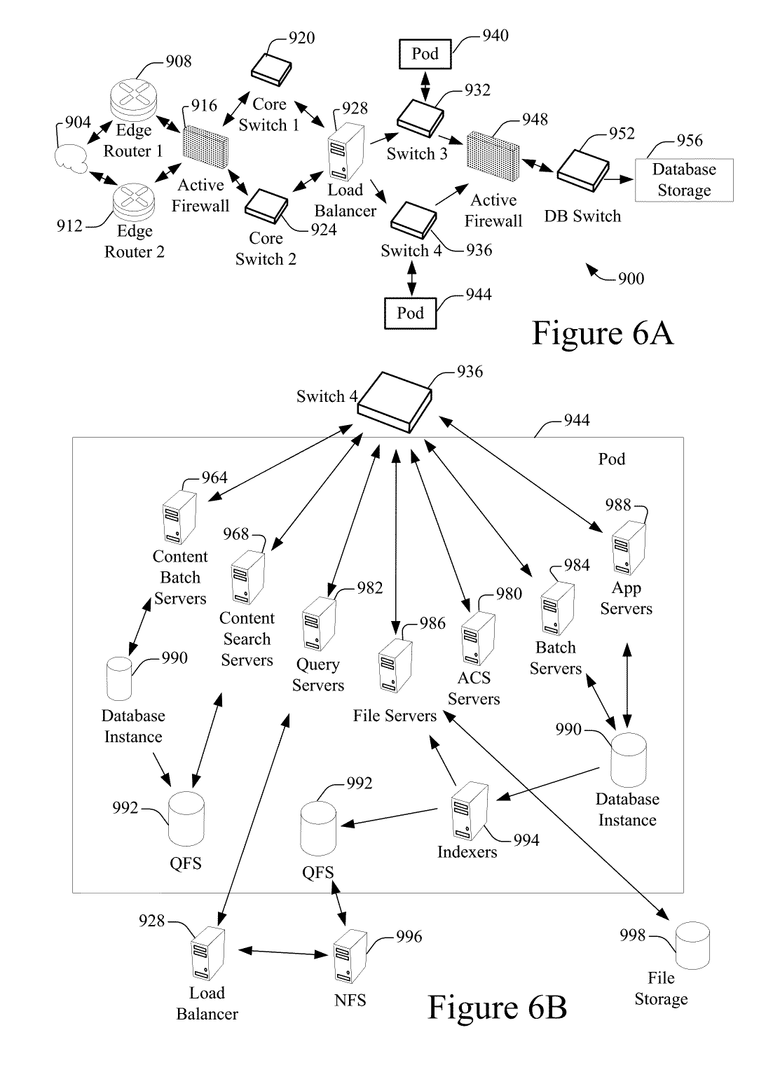

FIG. 6A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 6A and 6B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 6A and 6B, some implementations of an on-demand database service environment may include anywhere from one to many devices of each type. Also, the on-demand database service environment need not include each device shown in FIGS. 6A and 6B, or may include additional devices not shown in FIGS. 6A and 6B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 6B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 6A and 6B.

FIG. 6B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of an app server 988 is configured to execute operations of the services described herein, including performance of one or more of the operations of methods described herein with reference to FIGS. 1-4B. In alternative implementations, two or more app servers 988 may be included to perform such methods, or one or more other servers described herein can be configured to perform part or all of the disclosed methods.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database storing data objects identifying walkthrough stages, each walkthrough stage being associated with one or more features of an application or a service provided by one or more servers over a data network; and
one or more servers in communication with the database, the one or more servers comprising one or more processors operable to cause:
determining, responsive to receiving an identification of a first feature of a first application or service, that the first feature is associated with a first user interface layout of the application when presented in a user interface of a computing device;
identifying, based on the first user interface layout and one or more data objects in the database, one or more of the walkthrough stages as being relevant;
processing the one or more relevant walkthrough stages to generate a walkthrough; and
storing the walkthrough as a data file in a database of the database system, the walkthrough configured to be accessed via the data network and interacted with using the computing device.

2. The system of claim 1, wherein determining that the first feature is associated with the first user interface layout comprises:
analyzing one or more of: a Document Object Model (DOM) structure associated with the first feature, a Uniform Resource Locator (URL) associated with the first feature, or specified data associated with the first feature.

3. The system of claim 1, wherein processing the one or more relevant walkthrough stages to generate the walkthrough comprises:
replacing one or more of: a URL associated with one or more of the relevant walkthrough stages, a label associated with one or more of the relevant walkthrough stages, or a field associated with one or more of the relevant walkthrough stages.

4. The system of claim 1, the one or more processors further operable to cause:
generating a preview of the walkthrough, the preview configured to be accessed via the data network and interacted with using the computing device; and
providing, to the computing device, data capable of being processed by a processor of the computing device to display a presentation of the preview, the presentation of the preview capable of being interacted with by a user of the computing device to validate or modify the walkthrough.

5. The system of claim 4, the one or more processors further operable to cause:
determining a likelihood that the walkthrough accurately characterizes the first feature, the presentation of the preview comprising a graphical representation of the likelihood.

6. The system of claim 4, the one or more processors further operable to cause:
modifying the walkthrough according to a request from the computing device to modify the walkthrough; and
storing the modified walkthrough as a data file in a database of the database system.

7. The system of claim 1, the one or more processors further operable to cause:
ranking at least a portion of the walkthrough stages based on a number of walkthroughs associated with each walkthrough stage of the portion to determine a ranked list of walkthrough stages, the one or more relevant walkthrough stages being identified as relevant, at least in part, based on the ranked list.

8. The system of claim 1, the one or more processors further operable to cause:
updating, responsive to receiving an identification that a further walkthrough has been updated or generated for a second feature of the application or service, the second feature being associated with the first feature, the walkthrough.

9. The system of claim 1, wherein the first feature is associated with one or more of: a CRM (Customer Relationship Management) record, a type of data object, a tab, or a button.

10. A method for automatically generating a walkthrough of an application or an online service, the method comprising:
maintaining, by one or more servers associated with a database system, a database storing data objects identifying walkthrough stages, each walkthrough stage being associated with one or more features of an application or a service provided by one or more servers over a data network;
receiving, at the one or more servers, an identification of a first feature of a first application or service;
determining, responsive to receiving the identification, that the first feature is associated with a first user interface layout of the application when presented in a user interface of a computing device;
identifying, based on the first user interface layout and one or more data objects in the database, one or more of the walkthrough stages as being relevant;
processing, by the one or more servers, the one or more relevant walkthrough stages to generate a walkthrough; and
storing the walkthrough as a data file in a database of the database system, the walkthrough configured to be accessed via the data network and interacted with using the computing device.

11. The method of claim 10, wherein determining that the first feature is associated with the first user interface layout comprises:
analyzing one or more of: a Document Object Model (DOM) structure associated with the first feature, a Uniform Resource Locator (URL) associated with the first feature, or specified data associated with the first feature.

12. The method of claim 10, wherein processing the one or more relevant walkthrough stages to generate the walkthrough comprises:
replacing one or more of: a URL associated with one or more of the relevant walkthrough stages, a label associated with one or more of the relevant walkthrough stages, or a field associated with one or more of the relevant walkthrough stages.

13. The method of claim 10, further comprising:
generating a preview of the walkthrough, the preview configured to be accessed via the data network and interacted with using the computing device; and
providing, to the computing device, data capable of being processed by a processor of the computing device to display a presentation of the preview, the presentation of the preview capable of being interacted with by a user of the computing device to validate or modify the walkthrough.

14. The method of claim 13, further comprising:
determining a likelihood that the walkthrough accurately characterizes the first feature, the presentation of the preview comprising a graphical representation of the likelihood.

15. The method of claim 13, further comprising:
receiving a request from the computing device to modify the walkthrough;
causing the walkthrough to be modified according to the request; and
storing the modified walkthrough as a data file in a database of the database system.

16. A computer program product comprising computer-readable program code to be executed by one or more processors when retrieved from a non-transitory computer-readable medium, the program code including instructions configured to cause:
maintaining, by one or more servers associated with a database system, a database storing data objects identifying walkthrough stages, each walkthrough stage being associated with one or more features of an application or a service provided by one or more servers over a data network;
determining, responsive to receiving an identification of a first feature of a first application or service, that the first feature is associated with a first user interface layout of the application when presented in a user interface of a computing device;
identifying, based on the first user interface layout and one or more data objects in the database, one or more of the walkthrough stages as being relevant;
processing, by the one or more servers, the one or more relevant walkthrough stages to generate a walkthrough; and
storing the walkthrough as a data file in a database of the database system, the walkthrough configured to be accessed via the data network and interacted with using the computing device.

17. The computer program product of claim 16, wherein determining that the first feature is associated with the first user interface layout comprises:
analyzing one or more of: a Document Object Model (DOM) structure associated with the first feature, a Uniform Resource Locator (URL) associated with the first feature, or specified data associated with the first feature.

18. The computer program product of claim 16, wherein processing the one or more relevant walkthrough stages to generate the walkthrough comprises:
replacing one or more of: a URL associated with one or more of the relevant walkthrough stages, a label associated with one or more of the relevant walkthrough stages, or a field associated with one or more of the relevant walkthrough stages.

19. The computer program product of claim 16, the instructions further configured to cause:
generating a preview of the walkthrough, the preview configured to be accessed via the data network and interacted with using the computing device; and
providing, to the computing device, data capable of being processed by a processor of the computing device to display a presentation of the preview, the presentation of the preview capable of being interacted with by a user of the computing device to validate or modify the walkthrough.

20. The computer program product of claim 19, the instructions further configured to cause:
determining a likelihood that the walkthrough accurately characterizes the first feature, the presentation of the preview comprising a graphical representation of the likelihood.
